(19) United States
(12) Patent Application Publication
(10) Pub. No.: US 2016/0183045 A1
(43) Pub. Date: Jun. 23, 2016

(54) POSITIONING DEVICE AND POSITIONING METHOD THEREOF

(71) Applicant: AthenTek Inc., Taipei City (TW)

(72) Inventor: Chun-Nan Chen, Taipei City (TW)

(21) Appl. No.: 14/688,710

(22) Filed: Apr. 16, 2015

Related U.S. Application Data
(60) Provisional application No. 62/093,225, filed on Dec. 17, 2014.

(51) Int. Cl. H04W 4/02; H04W 4/00

(52) U.S. Cl. CPC H04W 4/02; H04W 4/008

(57) ABSTRACT

A positioning device and a positioning method thereof are provided. The positioning method, adopted by a first positioning device, including: establishing a short-range connection with a second positioning device upon detecting the second positioning device; receiving positioning information from the second positioning device via the short-range connection; and determining a first position of the first positioning device according to the positioning information.

### CROSS REFERENCE TO RELATED APPLICATIONS

This Application claims priority of U.S. Provisional Application No. 62/093,225, filed on Dec. 17, 2014, and the entirety of which is incorporated by reference herein.

### BACKGROUND OF THE INVENTION

1. Field of the Invention

The present invention relates to device positioning, and in particular to a positioning device and a positioning method thereof.

2. Description of the Related Art

Mobile phones nowadays can determine their locations by navigation signals from a satellite system (e.g., global positioning system or GPS) and an assistant navigation system (e.g., Assistant GPS or AGPS) or radio frequency signals from signal sources such as WiFi Access points (AP), and then upload their locations to a remote cloud server for provide positioning or tracking services for service subscribers.

A positioning device and a positioning method thereof are provided to identify the current location of the positioning device while increasing accuracy of the location determination.

### BRIEF SUMMARY OF THE INVENTION

A detailed description is given in the following embodiments with reference to the accompanying drawings.

An embodiment of a method is described, adopted by a first positioning device, comprising: establishing a short-range connection with a second positioning device upon detecting the second positioning device; receiving positioning information from the second positioning device via the short-range connection; and determining a first position of the first positioning device according to the positioning information.

Another embodiment of a first positioning device is provided, comprising a detection circuit, a transceiver circuit, a positioning information acquisition circuit and a position determination circuit. The detection circuit is configured to detect a second positioning device. The transceiver circuit is configured to establish a short-range connection with the second positioning device upon detecting the second positioning device. The positioning information acquisition circuit is configured to receive positioning information from the second positioning device via the short-range connection. The position determination circuit is configured to determine a first position of the first positioning device according to the positioning information.

### BRIEF DESCRIPTION OF THE DRAWINGS

The present invention can be more fully understood by reading the subsequent detailed description and examples with references made to the accompanying drawings, wherein:

FIG. 1 illustrates a positioning example according to an embodiment of the invention;

FIG. 2 illustrates a positioning example according to another embodiment of the invention;

FIG. 3 illustrates a positioning example according to another embodiment of the invention;

FIG. 4 is a block diagram of a BLE device 4 according to an embodiment of the invention;

FIG. 5 is a flowchart of a positioning method 5 according to an embodiment of the invention; and

FIG. 6 is a flowchart of a positioning method according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Various embodiments in the present application are in connection with short-range wireless communications which use Radio Frequency (RF) signals that travel in less than several meters. Examples of short-range wireless communications include, but are not limited to, Bluetooth, Bluetooth Low Energy (BLE), ultra-wideband and Zigbee.

In the present application, embodiments of the invention are described primarily in the context of a Bluetooth Low Energy (BLE) device. However, it should be appreciated that the invention is not intended to be limited to the context of a BLE device and may relate to any type of short-range communication device with a positioning capability. The BLE device may be a positioning device, a tracking device, cellular telephone, a smartphone, a pager, a media player, a gaming console, a Session Initiation Protocol (SIP) phone, Personal Digital Assistant (PDA), a tablet computer, a laptop computer, a handheld device having wireless connection capability, or a computing device. A signal source described herein is a wireless transmitter, including but not limited to, a Bluetooth device, an iBeacon Access Point (AP), a Wireless Fidelity (WiFi) AP, a cellular base station, or a navigation satellite.

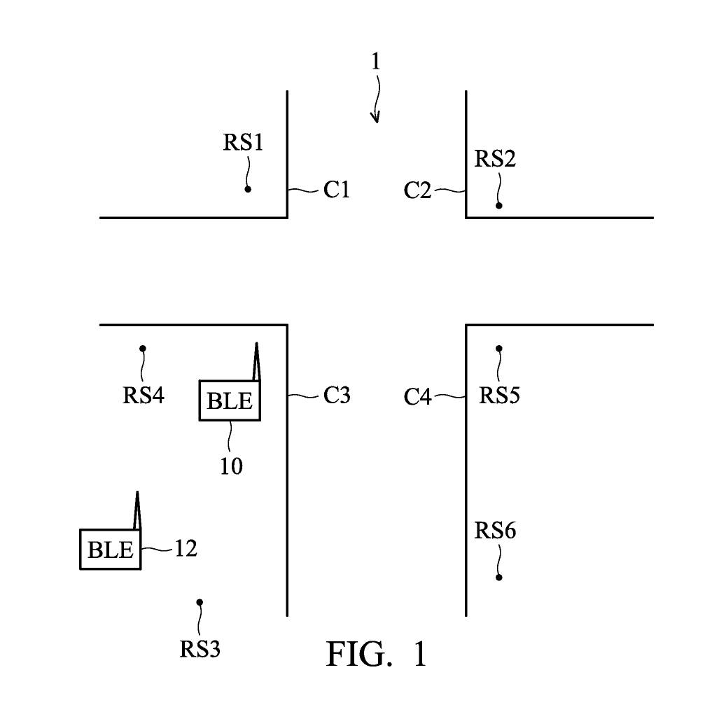

FIG. 1 illustrates a street environment of a road intersection for showing a positioning method according to an embodiment of the invention, including 4 corners C1 through C4. Each street corner contains one or more radio sources RS1 through RS6, the radio sources may be short-range device such as a WiFi AP, with a transmission range less than a few kilometers, or may be long-ranged device such as a GPS satellite, with a transmission range of a satellite distance. In FIG. 1, the radio sources RS1 through RS6 are WiFi APs disposed at difference parts of the street corners.

As being carried around to different parts of a building at the corner C4, BLE devices 10 and 12 (first and second positioning devices) may attempt to identify their respective positions by monitoring, measuring, or sniffing radio environments. The radio environment includes information of monitored or measured signal sources, including an identifier, an address, time-of-arrival (ToA), and signal strength of the monitored or measured signal source.

The BLE devices 10 and 12 may be paired previously. Once the BLE devices 10 and 12 are brought into proximity, they will sense and recognize each other and automatically form a BLE connection (short-range connection) therebetween. As a BLE device may sense the presence of another paired BLE device in a range less than 5 to 8 meters, it may acquire positioning information from the sensed BLE device to determine its current position.

In the embodiment, the BLE devices 10 and 12 may exchange the positioning information through the BLE connection and use the exchanged positioning information to determine their current positions. The positioning information is information used to determine a position of the BLE device, and may include an estimation of the position, or a radio signal measurement taken for estimating the position. For example, the positioning information may be a WiFi-signal measurement taken from the surrounding environment, the BLE device 10 may acquire the WiFi signal measurement taken by the BLE device 12 through the BLE connection.

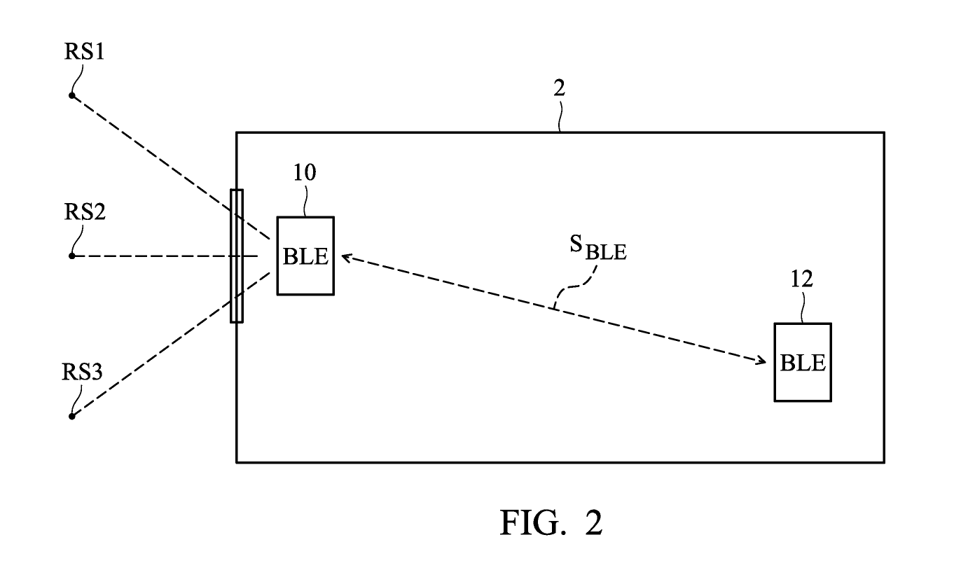

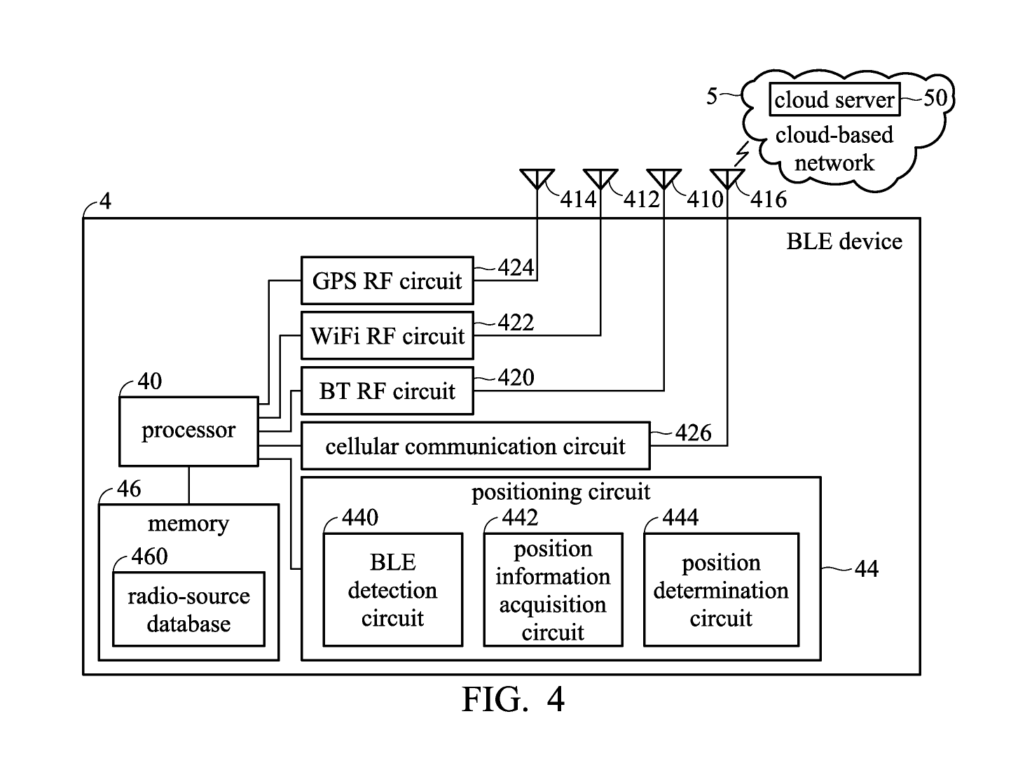

In another example, the positioning information may be a GPS position estimated by the GPS signals, the BLE device 12 may have estimated a GPS position and the BLE device 10 may acquire the GPS position estimation from the BLE device 12 through the BLE connection. The BLE device may use the acquired positioning information from the other BLE device and the positioning information detected by itself to determine its current position, as shown by an embodiment in FIG. 4. In another embodiment, the BLE device may use the position estimated from the other BLE device as the current position, as detailed in an embodiment in FIG. 2. Because the two BLE devices are located in a range less than 5 to 8 meters, they may share the same positioning information for determining their current positions, or even share the estimated position. The error of the estimated position may be kept within the range of 5 to 8 meters.

The BLE devices 10 and 12 may determine their positions by averaging positions of all radio sources. In particularly, the average may be performed by assigning appropriate weights to different radio sources (weighted average). The weights may be determined according to a level of confidence, which in term may be determined based on signal strength, a number of detected times, or TOA of the shared and detected radio sources.

In one implementation, the level of confidence is defined by signal strengths of the radio sources, and the position is determined by computing a weighted average according to signal strengths of the shared and detected radio sources. The BLE device 10 or 12 may obtain the positions of the radio sources from a radio source database, and average the positions of the radio sources according to the signal strengths, with a heavier weight being assigned to stronger signal strength, and a lighter weight being assigned to weaker signal strength. The radio source database may be located locally in the BLE device 10, 12, or in a cloud server on a cloud-based-server (not shown), which may be accessed by the BLE device 10, 12 through a wireless connection.

In another implementation, the level of confidence is defined by frequencies of detecting the radio sources, and the position is determined by computing a weighted average according to numbers of times that the shared and detected radio sources are detected in a given interval. The BLE device 10 or 12 may obtain the positions of the radio sources from the radio source database as disclosed in the preceding paragraph, and average the positions of the radio sources according to the numbers of times that the signal sources are detected, with a heavier weight being assigned to a more frequently detected radio source, and a lighter weight being assigned to a less frequently detected radio source.

In yet another implementation, the level of confidence is defined by time-of-arrival of the radio sources, and the position is determined by computing a weighted average according to the time-of-arrival of the shared and detected radio sources. The BLE device 10 or 12 may obtain the positions of the radio sources from the radio source database as disclosed in the preceding paragraph, and average the positions of the radio sources according to the time-of-arrival of the signal sources, with a heavier weight being assigned to a shorter time-of-arrival, and a lighter weight being assigned to a longer time-of-arrival.

In one example, the BLE device 10 may scan the radio environment and detect the radio sources RS1, RS2, RS4 and RS5, and the BLE device 12 may also scan its radio environment and detect the radio sources RS4, RS4 and RS6. After the BLE devices 10 and 12 senses each other, a BLE connection will be automatically established therebetween, and the BLE devices 10 and 12 will exchange the positioning information which includes the identifier, the address, the time-of-arrival and the signal strength of each detected radio source. That is, the BLE device 10 will receive the positioning information on the radio sources RS4, RS4 and RS6 from the BLE device 12, and the BLE device 12 will receive the positioning information on the radio sources RS1, RS2, RS4 and RS5 from the BLE device 10. Consequently the BLE devices 10 and 12 may determine their positions based on the shared positioning information of the radio sources RS1, RS2, RS4, RS4, RS5 and RS6. The same position may be derived for the BLE devices 10 and 12 based on the same set of positioning information of the radio sources RS1 through RS6. The BLE devices 10 and 12 may determine their positions based on one or more of the weighted average calculations described in the preceding paragraphs. By sharing the positioning information, the BLE devices 10 and 12 may estimate their positions with more positioning information, and therefore, the accuracy of the estimated positions is increased.

In another instance, the BLE devices 10 and 12 are also in close proximity and a BLE connection is formed therebetween. The BLE device 10 may have scanned the radio environment and determined a position based on the scan result and the weighted average calculation described in the preceding paragraphs. While the BLE device 12 is unable to determine its position because it is at a location with very weak radio signals and the scan result is insufficient for the BLE device 12 to determine its position. In such case, the BLE device 12 may receive the positioning information that includes the position of the BLE device 10 via the BLE connection and regard the position of the BLE device 10 as its position. By receiving the estimated position from the BLE device 10, the BLE device 12 may determine an approximation of its current position.

Accordingly, when the BLE devices 10 and 12 move into close proximity, they may determine their positions using exchanged positioning information, thereby providing a position approximation, or even increasing the accuracy of a position estimation.

Those skilled in the art would recognize that the embodiments of the present invention can be used in any environment, including but not limited to a street environment, a home environment, an office environment, and a retail environment. In addition, the BLE devices 10 and 12 may detect one another and transmit the positioning information by not only BLE, but also other short range communication technology. Moreover, the BLE devices 10 and 12 may acquire positioning information from two or more BLE devices in the close proximity, and determine their current positions by all available positioning information.

FIG. 2 illustrates a positioning example according to an embodiment of the invention, where the BLE devices 10 and 12 are located at different parts of a building 2 within a BLE detection range of each other.

As shown in FIG. 2, the BLE device 10 is moved to a location with good signal coverage, such as a window section, whereas the BLE device 12 is moved to another location with poor signal coverage, such as an in-building section. The BLE device 12 may not be able to, or may just barely receive RF signals from signal sources RS1, 2, and 3 due to the poor in-building coverage, and therefore, it becomes difficult for the BLE device 12 to determine its current position by collected signal measurements of the signal sources. The BLE device 10, on the hand, may well receive the RF signals from the signal sources RS1, 2, and 3, and may easily determine its current position by collected signal measurements of the signal sources RS1, 2 and 3. Because the BLE devices 10 and 12 are in the BLE detection range, they may establish a BLE connection therebetween, and the BLE device 10 may pass its current position as positioning information to the BLE device 12 via the BLE connection, so that the BLE device 12 may use the current position of the BLE device 10 as its current position. This approach allows the BLE device 12 to determine position estimation when only limited or no signal measurement is taken from the nearby radio sources.

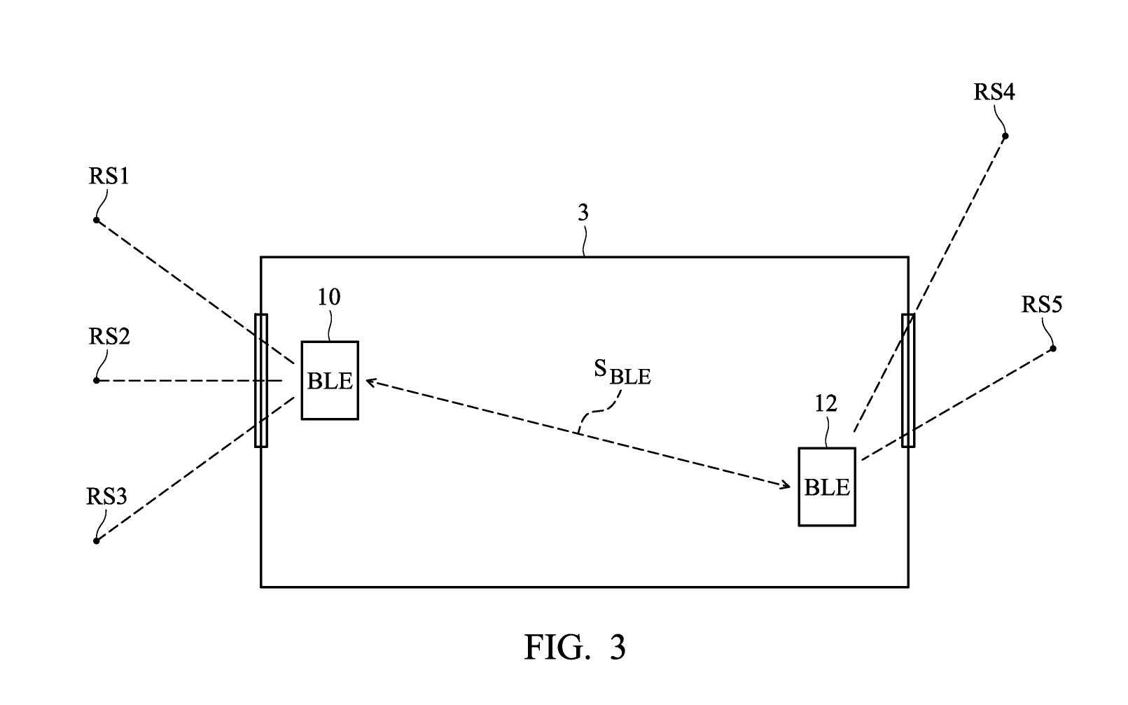

FIG. 3 illustrates a positioning example according to another embodiment of the invention, where the BLE devices 10 and 12 are located at different parts of a building 3 within a BLE detection range of each other.

As shown in FIG. 3, the BLE device 10 is moved to a front window section with signal coverage, and the BLE device 12 is moved to back window section, also with signal coverage. Both the BLE devices 10 and 12 may receive RF signals from certain but not all signal sources in the neighborhood. Specifically, the BLE device 10 may receive RF signals from signal sources RS1, 2, and 3 and the BLE device 12 may receive RF signals from signal sources RS4 and 5. Because each of the BLE devices 10 and 12 receives only signal measurements of partial but not full list of the signal sources in the neighborhood, they are unable to determine their positions accurately based on merely signal measurements of the detected signal sources. Instead, the BLE devices 10 and 12 may establish a BLE connection therebetween, exchange the signal measurements of their detected signal sources as positioning information to each other via the BLE connection, and compute their positions according to signal measurements of all available signal sources. That way, the BLE devices 10 and 12 may determine their positions with an increased accuracy.

FIG. 4 is a block diagram of a BLE device 4 according to an embodiment of the invention, including a processor 40, a Bluetooth (BT) RF circuit 420 (transceiver circuit), a WiFi RF circuit 422, a GPS RF circuit 424, a cellular communication circuit 426, a BT antenna 410, a WiFi antenna 412, a GPS antenna 414, a cellular communication antenna 416, a positioning circuit 44, and a memory device 46. The BLE device 4 may be used as the BLE devices 10 and 12 in FIG. 1. In addition, the BLE device 4 may determine its current position based on positioning information from a nearby BLE device and report its current position to a cloud server 50 in a cloud-based server 50.

The positioning circuit 44 is configured to determine the current position of the BLE device 4, and includes a BLE detection circuit 440 (detection circuit), a position information acquisition circuit 442, and a position determination circuit 444.

After power is turned on or the BLE function is initiated, the BLE detection circuit 440 is configured to constantly monitor for another BLE device in a detection range. When another BLE device is detected, a BLE connection will be automatically established between the BLE device 4 and the detected BLE device via the BT RF circuit 420 and the BT antenna 410. The position information acquisition circuit 442 is configured to acquire positioning information from the other BLE device that has established the BLE connection with the BLE device 4. In turn, the position determination circuit 444 is configured to determine the current position of the BLE device 4 based on the positioning information. The positioning information may be an estimated position such as a GPS position, or a radio signal measurement taken for estimating a position such as signal strength or time-of-arrival. The position determination circuit 444 may determine the current position of the BLE device 4 according to the positioning information, as explained in FIGS. 1 through 4. In particular, the position determination circuit 44 may perform weighted averaged according to a level of confidence determined by the positioning information, including signal strength, a number of detected times, or TOA of radio sources to determine the current position of the BLE device 4.

When the positioning information is a radio signal measurement, the position determination circuit 44 may determine the current position of the BLE device 4 according to the radio signal measurement and radio source information in a radio source database 460 in the memory device 46. The radio source information includes positions of radio sources which are measured and estimated previously, or imported from a known radio source database. In some embodiments, the radio source database 460 may be located at the cloud server 40 on the cloud-based network, which may be accessed by the BLE device 4 via the cellular communication circuit 426 and the cellular communication antenna 416.

Each of the BT RF circuit 420, the WiFi RF circuit 422 and the cellular communication circuit 426 includes a transmitter circuit for transmitting and a receiver circuit for receiving the respective Bluetooth, WiFi, and cellular signals via the respective Bluetooth antenna 410, the WiFi antenna 412 and the cellular communication antenna 416. The GPS RF circuit 424 includes a receiver circuit for receiving the GPS signals via the GPS antenna 414. The Bluetooth RF circuit 420, WiFi RF circuit 422, GPS RF circuit 424 and the respective Bluetooth antenna 410, WiFi antenna 412, GPS antenna 414 may operate concurrently, sequentially, or independently. The signal strength such as RSSI may be measured and computed by computation circuits (not shown) in the Bluetooth RF circuit 420, WiFi RF circuit 422, and GPS RF circuit 424. In some embodiments, the BLE device 4 may utilize the cellular communication circuit 426 and the cellular communication antenna 416 for communicating with a cloud-based network 5, and/or a radio access network and/or local area network, and/or point-to-point connection, including Global System for Mobile Communications (GSM), General packet radio service (GPRS), Enhanced Data rates for GSM Evolution (EDGE), Universal Mobile Telecommunications System (UMTS), Code Division Multiple Access 2000 (CDMA2000), Enhanced Voice-Data Optimized (EVDO), High Speed Packet Access (HSPA), HSPA plus (GSPA+), Time Division-Synchronous Code Division Multiple Access (TD-SCDMA), Worldwide Interoperability for Microwave Access (WiMAX), Long Term Evolution (LTE), and LTE-Advanced (LTE-A) systems.

The positioning circuit 44 may be implemented by hardware circuits, or software codes loadable and executable by the processor 4.

The embodiments of the BLE devices in FIGS. 1 though 4 utilize BLE communication to acquire positioning information from other BLE devices in the proximity and determine their current positions using all available positioning information, thereby positioning the BLE devices and increasing the accuracy of the positioning operations.

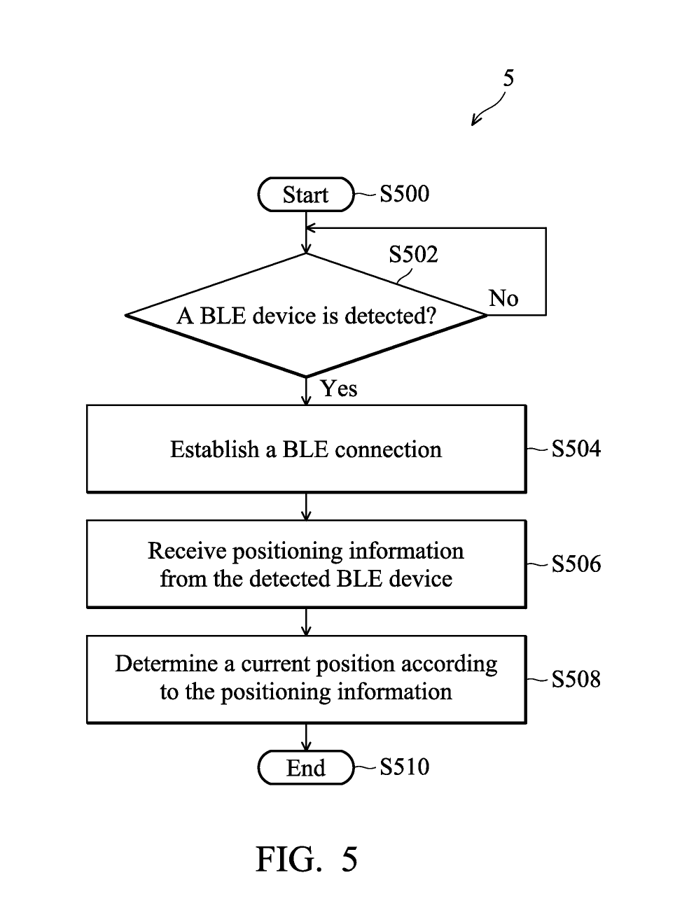

FIG. 5 is a flowchart of a positioning method 5 according to an embodiment of the invention, incorporating the BLE devices 10, 12, or 4 in FIGS. 1 though 4. In particular, the positioning method 5 may be implemented by the positioning circuit 44 in FIG. 4. The following will use the BLE device 4 to illustrate operations of the positioning method 5.

The positioning method 5 is initiated upon power-up or after the BLE detection function is activated (S500). After initialization, the BLE device 4 may constantly and periodically monitor for another BLE device in a BLE detection range and determine whether another BLE device is detected (S502). When the result is positive and the detected BLE device is a previously BLE-paired device, the BLE device 4 may automatically establish a BLE connection with the detected BLE device (S504). If the detected BLE device is not paired before, the BLE device 4 may perform a BLE pairing procedure with the detected BLE device and establish a BLE connection therebetween.

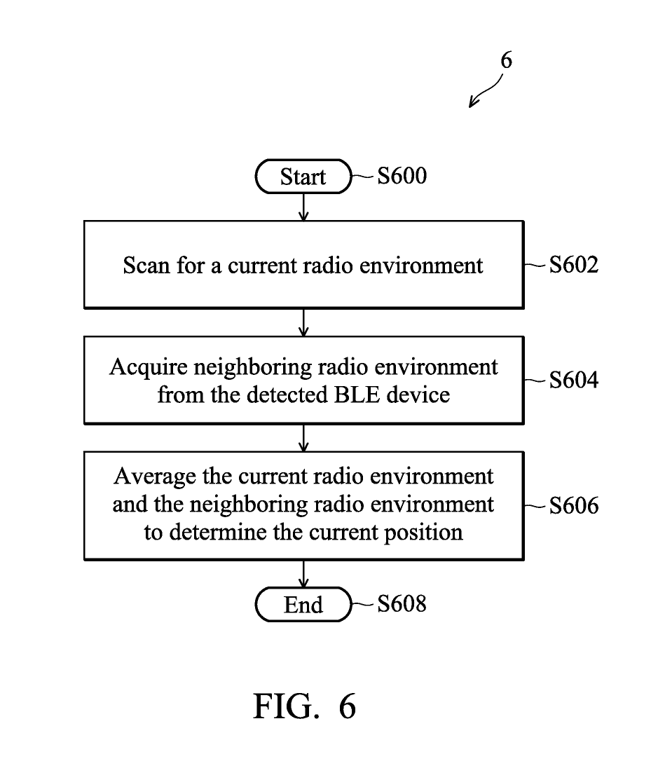

Next, the BLE device 4 may receive positioning information from the detected BLE via the BLE connection (S506), and determine its current position according to the positioning information (S508). Step S508 is further detailed in a positioning method 6 in FIG. 6.

The positioning method 6 is initiated for the BLE device 4 to determine a position (S600). After initialization, the BLE device 4 may scan for its current radio environment which includes Bluetooth, WiFi, GPS, or other cellular radio sources (S602), acquire neighboring positioning information from another BLE device in the detection range (S604), average all available positioning information, including the local positioning information and the neighboring positioning information, to determine the current position (S606). The local positioning information may include identifiers, addresses, time-of-arrival and signal strengths of radio sources in the local radio environment, and the neighboring positioning information may include identifiers, addresses, time-of-arrival and signal strengths of radio sources obtained from a neighboring BLE device. The available positioning information may be weighted averaged according to a level of confidence, which in term may be determined based on signal strength, a number of detected times, or TOA of the available radio sources.

The positioning methods 5 and 6 allow an BLE device to acquire positioning information from other BLE devices in the proximity through BLE communication and determine their current positions using all available positioning information, thereby positioning the BLE device and increasing the accuracy of the positioning operations under normal or weak signal conditions

As used herein, the term “determining” encompasses calculating, computing, processing, deriving, investigating, looking up (e.g., looking up in a table, a database or another data structure), ascertaining and the like. Also, “determining” may include resolving, selecting, choosing, establishing and the like.

The various illustrative logical blocks, modules and circuits described in connection with the present disclosure may be implemented or performed with a general purpose processor, a digital signal processor (DSP), an application-specific integrated circuit (ASIC), a field programmable gate array signal (FPGA) or another programmable logic device, discrete gate or transistor logic, discrete hardware components or any combination thereof designed to perform the functions described herein. A general-purpose processor may be a microprocessor, but in the alternative, the processor may be any commercially available processor, controller, microcontroller or state machine.

The operations and functions of the various logical blocks, modules, and circuits described herein may be implemented in circuit hardware or embedded software codes that can be accessed and executed by a processor.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A positioning method, adopted by a first positioning device, comprising:
establishing a short-range connection with a second positioning device upon detecting the second positioning device;
receiving positioning information from the second positioning device via the short-range connection; and
determining a first position of the first positioning device according to the positioning information.

2. The positioning method of claim 1, wherein
the positioning information is a second radio environment of the second positioning device; and
the step of determining the first position of the first positioning device comprises: computing the first position of the first positioning device by the second radio environment of the second positioning device and a first radio environment of the first positioning device.

3. The positioning method of claim 1, wherein the first positioning device and the second positioning device are Bluetooth Low Energy (BLE) devices, and the short-range connection is a BLE connection.

4. The positioning method of claim 2, wherein the first and second radio environments comprises a radio source and an identifier, an address, a time-of-arrival and signal strength of the radio source of the first positioning device and the second positioning device, respectively.

5. The positioning method of claim 2, wherein the step of computing the first position of the first positioning device comprises: averaging the first radio environment of the first positioning device and the second radio environment of the second positioning device to compute the first position of the first positioning device.

6. The positioning method of claim 2, wherein the step of computing the first position of the first positioning device comprises: computing a weighted average of the first radio environment of the first positioning device and the second radio environment of the second positioning device based on signal strengths of the first second radio environment and the second radio environment to determine the first position of the first positioning device.

7. The positioning method of claim 2, wherein the step of computing the first position of the first positioning device comprises: computing a weighted average of the first radio environment of the first positioning device and the second radio environment of the second positioning device based on a first number of time which the first radio environment is detected and a second number of time which the second radio environment is detected to determine the first position of the first positioning device.

8. The positioning method of claim 2, wherein the step of computing the first position of the first positioning device comprises: computing a weighted average of the first radio environment of the first positioning device and the second radio environment of the second positioning device based on time-of-arrival to determine the first position of the first positioning device.

9. The positioning method of claim 2, wherein the radio source comprises a WiFi, a Bluetooth, and a GPS radio source.

10. The positioning method of claim 1, wherein
the positioning information is a second position of the second positioning device; and
the step of determining the first position of the first positioning device comprises: setting the first position of the first positioning device as the first position of the first positioning device.

11. A first positioning device, comprising: a detection circuit, configured to detect a second positioning device;
a transceiver circuit, configured to establish a short-range connection with the second positioning device upon detecting the second positioning device;
a positioning information acquisition circuit, configured to receive a positioning information from the second positioning device via the short-range connection; and
a position determination circuit, configured to determine a first position of the first positioning device according to the positioning information.

12. The first positioning device of claim 11, wherein
the positioning information is a second radio environment of the second positioning device; and
the position determination circuit is configured to compute the first position of the first positioning device by the second radio environment of the second positioning device and a first radio environment of the first positioning device.

13. The first positioning device of claim 11, wherein the first positioning device and the second positioning device are Bluetooth Low Energy (BLE) devices, and the short-range connection is a BLE connection.

14. The first positioning device of claim 12, wherein the first and second radio environments comprises a radio source and an identifier, an address, a time-of-arrival and signal strength of the radio source of the first positioning device and the second positioning device, respectively.

15. The first positioning device of claim 12, wherein the position determination circuit is configured to average the first radio environment of the first positioning device and the second radio environment of the second positioning device to compute the first position of the first positioning device.

16. The first positioning device of claim 12, wherein the position determination circuit is configured to compute a weighted average of the first radio environment of the first positioning device and the second radio environment of the second positioning device based on signal strengths of the first second radio environment and the second radio environment to determine the first position of the first positioning device.

17. The first positioning device of claim 12, wherein the position determination circuit is configured to compute a weighted average of the first radio environment of the first positioning device and the second radio environment of the second positioning device based on a first number of time which the first radio environment is detected and a second number of time which the second radio environment is detected to determine the first position of the first positioning device.

18. The first positioning device of claim 12, wherein the position determination circuit is configured to compute a weighted average of the first radio environment of the first positioning device and the second radio environment of the second positioning device based on time-of-arrival to determine the first position of the first positioning device.

19. The first positioning device of claim 12, wherein the radio source comprises a WiFi, a Bluetooth, and a GPS radio source.

20. The first positioning device of claim 11, wherein
the positioning information is a second position of the second positioning device; and
the position determination circuit is configured to set the first position of the first positioning device as the first position of the first positioning device.
